(19) United States
(12) Patent Application Publication
(10) Pub. No.: US 2026/0300805 A1
(43) Pub. Date: Oct. 1, 2026

(54) OFF-POLICY EVALUATION FRAMEWORK

(71) Applicant: Microsoft Technology Licensing, LLC, Redmond, WA (US)

(72) Inventor: Ghulam Ahmed ANSARI, Fremont, CA (US)

(21) Appl. No.: 19/090,985

(22) Filed: Mar. 26, 2025

(51) Int. Cl. G06N 20/00

(52) U.S. Cl. CPC G06N 20/00

(57) ABSTRACT

Aspects of the disclosure include methods and systems for an off-policy evaluation (OPE) framework for parameter-free, model-free score alignment across content ranking architectures. A method includes receiving one or more candidate models and generating uncalibrated scores for the models. Calibrated scores are assigned to the uncalibrated scores by quantizing the uncalibrated scores into two or more discrete bins, each bin of the two or more discrete bins mapped to a discrete range of uncalibrated scores for the candidate items. The discrete bins are assigned asymmetrical score ranges selected such that a difference between a number of uncalibrated scores assigned to each discrete bin is below a predetermined threshold. Probabilistic scores are assigned to each bin and calibrated scores are assigned to the uncalibrated scores based on the respective bin assignments of the uncalibrated scores. Off-policy estimates are then leveraged to ramp a model of the one or more candidate models.

### INTRODUCTION

The subject disclosure relates to connections networks, online platforms, and content recommendation, and specifically to an off-policy evaluation (OPE) framework for model-free score alignment to ramp best performing models by comparing ranking models across content ranking architectures.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 is a functional block diagram illustrating an example of a feed service with which an embodiment of the present disclosure may be implemented and deployed;

FIG. 2 depicts a universal off-policy estimator for the feed service of FIG. 1 in accordance with one or more embodiments;

FIG. 3 depicts a process for leveraging a universal off-policy estimator for a feed service in accordance with one or more embodiments;

FIG. 4 depicts a block diagram of a multilayer perceptron-type model implementation in accordance with one or more embodiments;

FIG. 5 depicts a block diagram of a transformer-type model implementation in accordance with one or more embodiments;

FIG. 6 depicts a block diagram of a computer system in accordance with one or more embodiments;

FIG. 7 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Online platforms such as connections networks face significant technical challenges related to content serving due in part to the enormous scale of these systems and the sheer variety and amount of candidate content available for delivery to users. To illustrate these challenges, consider that online platforms would ideally serve only desired content to users (that is, content for which the receiving user is pleased to receive). Therefore, to improve the desirability of delivered content, candidate content (also referred to as candidate items) might be evaluated, scored, ranked, and ultimately delivered to the users of the underlying platform according to their respective rankings. Evaluating and ranking candidate content is technically challenging, however, due to a number of factors. One of the technical challenges associated with the ranking of candidate content is simply the diversity and volume of content available for serving to users. Put simply, it is not straightforward to rank varied candidate content of differing types and/or modalities in a consistent manner.

One approach to this technical problem is to design and implement a set of single-objective models, where each model is trained to evaluate and rank a specific type, class, or modality of candidate items. For example, a first single-objective model might be leveraged to rank video content, while a second single-objective model might be used to rank candidate notifications. In another approach, a single multi-objective model can be configured to evaluate content items across a number of simultaneous objectives, such as predicted user engagement, content relevancy, recency, etc. In any case, these multi-single object model and multi-objective model ranking schemes raise their own technical challenges-namely, it becomes necessary to align the scores (ranking metrics) across the different underlying ranking architectures and objectives to ensure a consistent ranking policy irrespective of the specific evaluation and logging models, methodologies, score distributions, scale, shift, etc., of the underlying models. Failing to properly align scores across different ranking architectures can lead to inconsistencies and inaccuracies in the final model evaluation (for example, some scores can become biased against other scores, some models can become biases against other models, etc.). This results in an effective loss of ranking capability and can result in these model architectures inadvertently serving less desirable content to users.

Unfortunately, cross-model score alignment is not trivial. To illustrate, consider an example scenario where it is desirable to apply off-policy estimations to a collection of candidate items in a recommendation session initially scored using a variety of first pass rankers (FPRs) for collective re-evaluation (or re-ranking) by a second pass ranker (SPR). Off-policy estimation (or off-policy evaluation) refers to the use of data collected by an existing policy to evaluate the performance of a new policy. In the context of ranking models, “off-policy estimation” refers to the evaluation of the performance of a ranking model (a policy) using data collected using a different, previously deployed ranking model (that is, under a different policy). Off-policy estimation allows for the assessment of new or experimental models without deploying them in a live environment, thereby avoiding potential risks associated with online testing. To ensure score alignment in this scenario, it is necessary to ensure that the underlying model scores used for evaluation (e.g., the output probabilities) are valid likelihoods (e.g., probability estimates). Notably, however, this will not always be the case. In particular, this assumption does not hold for second pass rankers (SPRs) or first pass rankers (FPRs) where a final model score is derived through a multi-objective optimization (MOO) process. More specifically, the output scores from an MOO process can, theoretically, include any float value in the range (−∞,+∞), making these scores unsuitable as probability estimates. In other words, the outputs from these and some other model types may not be probabilities that can be directly used for cross-score alignment.

In attempting to address this issue, it might seem reasonable to apply a softmax transformation over the scores as, given a set of scores S={S₁, S₂, . . . , Sₖ}, the softmax transformation will output transformed scores in the range [0, 1] that sum to 1. Some existing ranking architecture rely on this technique. The softmax transformation, however, is only effective for computing propensity weights in off-policy estimation when the logging policy (the policy that collected the data) and the evaluation policy (the policy being tested) are similar in terms of range and scale. Under these conditions, softmax can preserve relative score rankings between models and can therefore provide a reasonable proxy for probabilities. However, when the logging and evaluation policies differ in terms of range and scale, the softmax-transformed scores can fail to approximate the true likelihoods, and thus the true relationship between scores and probabilities can become distorted, leading to inaccuracies in the propensity weights and downstream content serving determinations.

To illustrate, consider a scenario in which both the baseline model and treatment model of an SPR uses the softmax transformation to convert scores into probabilities. Consider further that the baseline model is an MOO model with scores {S₁, S₂, S₃} equal to {2.1, 3.0, 1.5} and the treatment model is an MOO model with scores {S₁′, S₂′, S₃′} equal to {22.1, 33.0, 15.0}. Observe that, due to the relatively larger scale of the scores introduced by the treatment model, that the softmax probabilities will become skewed (refer, e.g., to the following softmax formula (1)).

$${P}_{baseline} ( {S}_{i} ) = \frac{exp ( {S}_{i} )}{{\sum }_{j = 1}^{k} exp ( {S}_{j} )} \qquad ( 1 )$$

More specifically, candidate items with relatively lower scores in the treatment model can be assigned near-zero probabilities, even if those candidate items would have been plausible under the baseline model. Thus, it is desirable to provide an architecture that can calibrate non-probabilistic scores and to align those scores in a manner that represents valid probabilities (likelihoods) before running downstream Off-Policy Evaluation (OPE) processes.

This disclosure introduces an off-policy evaluation framework for parameter-free, model-free score alignment. Rather than relying directly on raw model scores and softmax transformations for score alignment across a number of models, a model-free score calibration module is introduced herein that leverages quantized score mapping and a learned binning-based likelihood approximation for model-agnostic score calibration and alignment. More specifically, for each model, raw candidate item scores are quantized into discrete bins, each representing a range of raw scores for the respective model. Then, for each bin i, the model-free score calibration model learns a bin-based probability score (e.g., a positive label likelihood) for candidate items having raw scores which fall within the range of the scores in bin i. This binning process can be repeated for any number of models for which score alignment is desired or required. Once the bin-based probability scores are known, raw scores can be efficiently mapped, during inference, to their respective bins and assigned to the probabilities directly using the precomputed likelihoods for each bin. The raw scores can be replaced with bin-based probability scores in downstream tasks, enabling efficient and robust Off-Policy Evaluation. In this manner, the off-policy evaluation framework enables a fair and accurate comparison of recommendation strategies, regardless of the specific technique behind each ranking system (e.g., pointwise vs. listwise vs. pairwise ranking paradigms, etc.).

The off-policy evaluation framework described herein offers a number of technical advantages over prior OPE systems. Advantageously, the model-free score calibration module leverages quantized score mapping and binning-based likelihood approximations in a manner which ensures that the learned probabilities are invariant to MOO scaling, stabilizing weights and metric estimates across any number of models. This makes it possible to apply OPE to diverse ranking problems, even when the involved ranking models do not output raw probability measures and/or when their outputs vary arbitrarily in terms of range and scale. For example, the off-policy evaluation framework described herein provides stable outputs even when the scale of a first model is an order of magnitude higher (or several orders of magnitude higher) than the scale of a second model (e.g., model 1 scores [1.5, 2.1, 5.3] vs. model 2 scores [16, 24, 47]). Notably, this scenario is unstable using softmax-based techniques. As used herein, an unstable output refers to an output which transforms low raw scores (e.g., 0.1 to 0.4) to near-zero (e.g., under 0.1) probabilities due to softmax skew. Softmax skew can result, for example, in assigning all raw scores to near-zero probabilities, except for a highest raw score, for models having raw scores that are an order of magnitude or higher than other models in the underlying score alignment process. This approach also addresses inconsistencies arising from score transformation-based techniques, such as softmax transformations or so-called extreme scaling, ensuring reliable and accurate off-policy evaluation. Moreover, quantized score mapping natively ensures data interpretability and scalability for arbitrarily large datasets, meaning that solutions described herein are not limited by dataset constraints. Notably, because the off-policy evaluation framework described herein offers model and parameter-free score alignment, there is no need for hyperparameter tuning or cross-validation, ensuring computational efficiency even in large-scale environments having tens or hundreds of models (or more) and thousands or millions (or more) candidate items. Hyperparameter tuning typically involves systematically adjusting the parameters that govern the learning process of a model, such as learning rate, regularization strength, and the number of layers in a neural network. This process often requires running multiple iterations of model training and evaluation to identify the optimal set of hyperparameters. Each iteration can be computationally demanding, as it involves training the model on the entire dataset, which can be particularly resource-intensive when dealing with large datasets or complex models. Cross-validation is a technique used to assess the generalizability of a model by partitioning the dataset into multiple subsets and training the model on different combinations of these subsets. This process helps ensure that the model performs well on unseen data and is not overfitting to the training data. However, cross-validation requires multiple rounds of training and evaluation, further increasing the computational load associated with the overall training scheme. In other words, hyperparameter tuning and cross-validation are computationally intensive, and avoiding these processes results greatly increases training efficiency by significantly lowering compute requirements.

### Detailed Embodiment

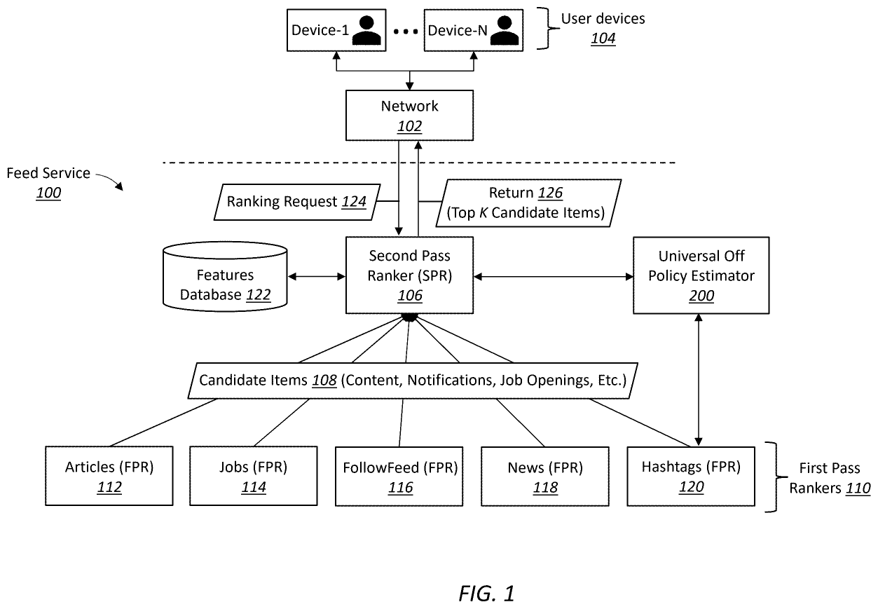

FIG. 1 is a functional block diagram illustrating an example of a feed service 100 in which an embodiment of the present invention may be implemented and deployed. The feed service 100 can be used to serve content over a network 102 to user devices 104. Feed service 100 can be a large-scale online service serving many users (e.g., thousands of users, millions of users, hundreds of millions of users, or more). In some embodiments, the feed service 100 may be used to customize a content feed to the attributes, behavior, and/or interests of members or related groups of members (e.g., connections, follows, schools, companies, group activity, member segments, etc.) in a connections network, social network and/or online professional network, as desired. The type of content served is not meant to be particularly limited, but can include, for example, connection recommendations (e.g., people you may know), user profiles and/or links to user profiles, job postings, user posts, status updates, user and/or system messages, sponsored content, event descriptions, articles, images, audio data, video data, documents, and/or other types of content.

Network 102 can include a data communications network and can encompass one or more different types of networks. For example, network 102 can encompass one or more cellular networks (e.g., GSM, IS-95, UMTS, CDMA2000, LTE, 5G, etc.), one or more wireless networks (e.g., an IEEE 802.11 network), and/or one or more internet protocol (IP) networks (e.g., the Internet).

User devices 104 (e.g., Device-1, Device-2, . . . , Device-N) can include many different types of electronic and personal computing devices. For example, a user device 104 can be stationary computer such as a desktop or workstation computer or the like. A user device 104 can be a portable computer such as a laptop computer, a tablet computer, a mobile phone, a smart phone, or the like. A user device 104 can include, or be operatively coupled to, a computer display screen on which a graphical user interface (GUI) driven by the feed service 100 can be presented to a user via the user device 104. The graphical user interface can encompass web pages, web content, or the like served by the feed service 100 to user devices 104 over network 102. The online service can drive the graphical user interface with the aid of a client application that is installed and executing the user device 104. The client application can be a web browser application or a mobile application, for example.

As shown in FIG. 1, feed service 100 can include a second pass ranker (SPR) 106. In some embodiments, SPR 106 is configured to score and select content for serving to the user devices 104 over the network 102. In some embodiments, the SPR 106 operates by re-ranking candidate items 108 that have been preliminarily selected by one or more first pass rankers (FPRs) 110. This re-ranking process ensures that the most relevant and engaging content is prioritized for delivery to the user devices 104. In some embodiments, SPR 106 is configured to combine and score the output from one or more, or even all, of the FPRs 110.

The primary function of the FPRs 110 is to quickly and efficiently filter and rank a large pool of potential content items. In some embodiments, the FPRs 110, in contrast to the SPR 106, are each specialized in handling a specific type of content, such as articles, job postings, user posts, sponsored content, etc. The FPRs 110 operate by querying data stores to retrieve content items that match certain criteria relevant to the user. These criteria can include user preferences, past interactions, content attributes, and other contextual information. In some embodiments, each FPR 110 applies its own learned and/or heuristic ranking algorithm to score and rank the retrieved content items, producing a preliminary list of candidate items 108. This initial ranking can be based on features such as a user's engagement history, the popularity of the content, and the relevance of the content to a user's current context. For example, in some embodiments, FPRs 110 create a preliminary candidate selection (the candidate items 108) from their shared or segmented inventories based on predicted relevance to the intended user of the users 104. The candidate items 108 can be ranked using parameters related to the user's connections, groups, follows, activities, interests, associated companies, etc., in the underlying connections network, as well as other parameters such as updates made to the user's profile, job status, etc., skill recommendations by other users on the network, etc. For example, a news-type FPR might create a list of preliminary candidate news items for a user based on personalized user features such as the types and length of news content consumed by the user in the last 1, 5, 30 days, etc., in addition to non-personalized features, such as, for example, the length of a candidate news item, the type of content of a candidate news item, the time of day, the day/month of the year, etc.

In the example of FIG. 1, first pass rankers 110 include an articles first pass ranker 112 for scoring article feed items, a jobs first pass ranker 114 for scoring job feed items, a followfeed first pass ranker 116 for scoring follow feed items, a new first pass ranker 118 for scoring news feed items, and a hashtags first pass ranker 120 for scoring hashtag feed items. Article feed items scored by articles first pass ranker 112 can include user authored articles, scholarly articles, informational articles, and other types of written articles. An article feed item can contain, or link to, the text of an authored article and any associated media. Job feed items scored by the jobs first pass ranker 114 can include job opening, job postings, job listings, employment opportunities, or the like. A job feed item can contain, or link to, a text description of the job such as, for example, job requirements and any associated media. Follow feed items scored by followfeed first pass ranker 116 can include activities by users interacting with feed items in their personalized feeds. Such feed item interaction activities can include, but are not limited to, liking a feed item, sharing a feed item with one or more other users in a connections network, commenting on a feed item, and clicking on (viewing) a feed item, etc. A follow feed item can contain, or link to, a text description of a user activity and any associated media. News feed items scored by news first pass ranker 118 may include news articles, news reports, or the like. A news feed item can contain, or link to, the text of the news article and any associated media. Hashtag feed items scored by hashtags first pass ranker 120 may include social network posts, comments, tweets, photo shares, or the like that include different hashtags (e.g., “#moving”, “#selfie”, “#happy”) or other types of metadata or hashtags. A hashtag feed item can contain, or link to, the text containing a hashtag or metadata tag. First pass rankers 110 shown in FIG. 1 are provided merely as an example of a possible set of first pass rankers that can be used in the feed service 100. It should be understood that more first pass rankers, or less, or an entirely different set of first pass rankers can be used in a particular implementation, as desired. More or fewer first pass rankers 110 can also be used in a particular implementation. For example, as few as a single first pass ranker 110 can be used in an implementation. Alternatively, more than five (5) first pass rankers 110 can be used in an implementation, such as 10, 20, 100, etc. In addition, it is not necessary for a first pass ranker 110 to score a homogeneous type of feed items, and a single first pass ranker 110 can score heterogeneous types of feed items. For example, a single first pass ranker 110 can be used to score all of article feed items, jobs feed items, follow feed items, news feed items, and hashtag feed items, as desired.

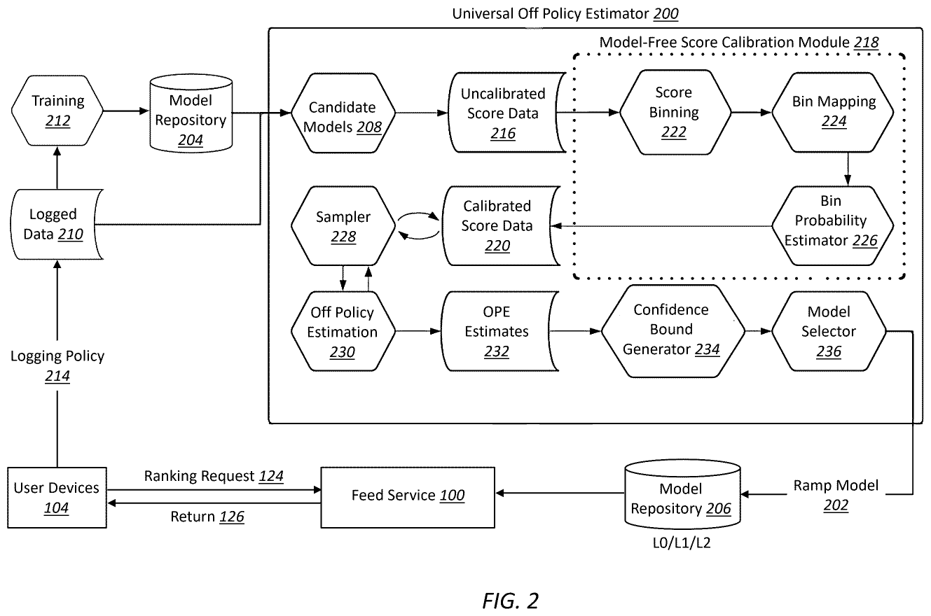

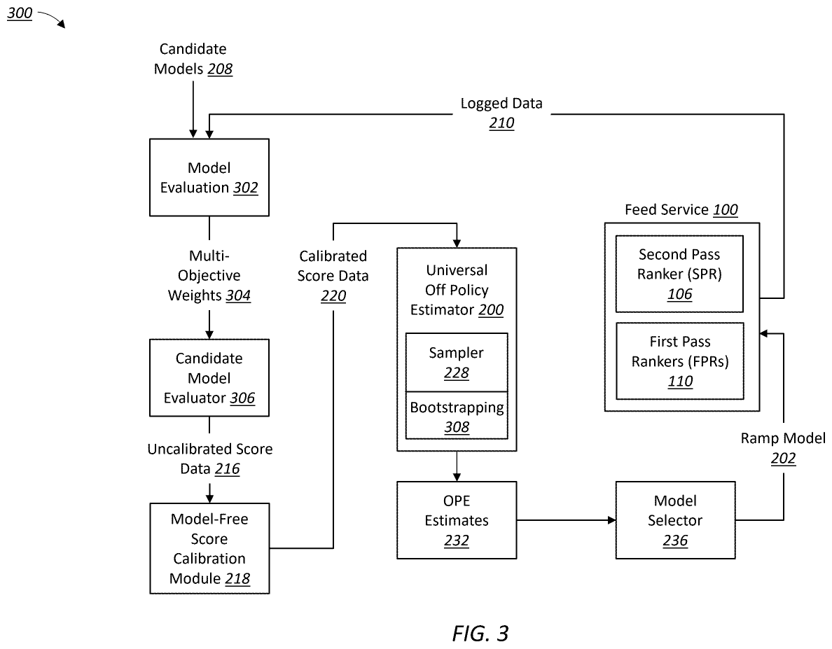

Returning now to the SPR 106, in some embodiments, SPR 106 includes one or more models selected for online serving (referred to as ramped) from a plurality of candidate models trained or heuristically tuned to rank the candidate items 108 (refer to FIG. 2). In some embodiments, the ramped model(s) are selected according to an output of a universal off-policy estimator 200 (refer to FIGS. 2 and 3). Once ramped, the SPR 106 can leverage a combination of supervised learning, unsupervised learning, and other machine learning techniques to rank the candidate items 108.

In some embodiments, when scoring (or re-scoring) the candidate items 108, the SPR 106 can accept a variety of different machine learning features as input. The features accepted as input can include, but are not limited to, features of the intended user (“viewer features”), features of the candidate item (“feed item features”), features of both the user and the feed item (“viewer-feed item features”), features of the actor associated with the candidate item (“actor features”), features of both the user and the actor of the feed item (“viewer-actor features”), features combining aspects of each of the viewer, the actor, and the feed item (“viewer-actor-feed item features”), and global features. Note that, as used herein, the “actor” of a candidate item refers to the entity (e.g., another user, a company, an advertiser, etc.) that took the action(s) that caused the respective feed item to be served to the user. Note that, in some cases, the actor and the user are the same entity. On the other hand, in other scenarios, the actor and the user are different entities. In still other cases, there is no actor per se, as the feed items might be served to the user according to user and/or candidate item features and a predetermined schedule. In some embodiments, features can be stored in a features database 122 accessible to the feed service 100 and/or second pass ranker 106. In some embodiments, features database 122 can also be accessible to one or more of the first pass rankers 110.

In some embodiments, a ranking request 124 (also referred to as a personalized feed request) can be sent from or on behalf of a user device 104 (e.g., Device-1, . . . , Device-N) over network 102 to the feed service 100 and/or second pass ranker 106. In some embodiments, ranking request 124 includes a request to provide the top K candidates of a plurality of candidates (e.g., the candidate items 108) for delivery to the user device 104. In some embodiments, SPR 106 can, responsive to receiving the ranking request 124, return 126 (e.g., “surface”, or “impress”) one or more candidate items 108 to the user device 104 over network 102, where a user can view or otherwise interact with the associated content items. The ranking request 124 can be carried in one or more hypertext transfer protocol (HTTP) requests or one or more secure-hypertext transfer protocol (HTTPS) requests. Similarly, in some embodiments, the return 126 for the personalized feed request can be sent from the feed service 100 and/or second pass ranker 106 over network 102 to the associated user device 104 in one or more HTTP or HTTPS responses. The present disclosure is not limited to HTTP or HTTPS for sending and responding to feed requests, as these are merely illustrative. Other suitable application-layer protocols can be used such as, for example, an application-layer protocol suitable for implementing remote procedure calls (RCPs) or messaging queuing (e.g., the Advanced Message Queuing Protocol (AMQP)).

FIG. 2 depicts a universal off-policy estimator 200 for the feed service 100 of FIG. 1 in accordance with one or more embodiments. As shown in FIG. 2, the universal off-policy estimator 200 can be leveraged to select an SPR and/or FPR model(s) (referred to as ramp model 202) for the feed service 100 from one or more candidate models stored in a model repository 204. The ramp model 202 can include the second pass ranker 106 and/or any (or all) of the first pass rankers 110, as desired (refer to FIG. 1). The ramp model 202 can be stored in a model repository 206 accessible to the feed service 100. The model repository 206 can be the same repository, or a different repository, than the model repository 204.

In some embodiments, model repository 204 is an experimental model repository having stored therein a number of candidate models 208 for the feed service 100. In some embodiments, candidate models 208 (also referred to as experimental models) within the model repository 204 are models that are trained on logged data 210 (also referred to as training data) during a training phase (training 212). In some embodiments, logged data 210 is collected from user devices 104 according to a logging policy 214. A logging policy 214 refers to the set of rules or guidelines that dictate how data, such as user interactions on a connections network, are recorded and stored during the operation of the user device 104 and/or the feed service 100. The logging policy 214 determines which events or actions are captured, how frequently data is logged, the level of detail included in the logs, etc. The logging policy 214 underlying the logged data 210 therefore governs the selection of training data for training 212 the candidate models 208 within the model repository 204. For example, in a content recommendation system, a logging policy 212 might specify that every time a user clicks on a recommended article, the event is logged along with metadata such as the time of the click, a user identifier, an article identifier, and/or any number of the user's previous interactions with similar content (as determined, e.g., according to a number of shared characteristics and/or a distance measure in an embedding space). In this scenario, logged data 210 can then be used to train candidate models 208 to predict user article preferences, thereby improving the accuracy of future article recommendations.

In any case, as further shown in FIG. 2, one or more of the candidate models 208 and, optionally, the logged data 210, can be transmitted to, or fetched, by the universal off-policy estimator 200. In some embodiments, at least two candidate models 208 are served to the universal off-policy estimator 200. The universal off-policy estimator 200 selects, from the at least two candidate models 208, the one or more ramp model(s) 202. Model selection is discussed in greater detail herein.

In some embodiments, uncalibrated score data 216 (also referred to as raw scores) are generated for one or more of the candidate models 208. In some embodiments, uncalibrated score data 216 are generated for the logged data 210. For example, consider a scenario in which three candidate evaluation models (e.g., candidate models for a second pass ranker and/or a first pass ranker of FIG. 1) produce scores for three test documents (note that 3 models are selected for ease of discussion only, the process is the same using two models, or more than 3 models, etc.). The uncalibrated score data 216 might be as follows: Model 1 [1.35, 1.65, 1.14], Model 2 [13.0, 16.2, 12.7], and Model 3 [133, 161, 130]. The uncalibrated score data 216 is passed to a model-free score calibration module 218 which produces, from the uncalibrated score data 216, calibrated score data 220.

To generate the calibrated score data 220, the model-free score calibration module 218 quantizes the uncalibrated score data 216 into discrete bins (referred to herein as score binning 222). In some embodiments, each bin x_{bin} represents a range of scores in the uncalibrated score data 216. For example, a first bin x₁ might represent raw scores between 0 and 0.2, while a second bin x₂ might represent raw scores between 0.2 and 0.6, and so on. Advantageously, rather than taking a naïve approach, where each bin might represent equivalent intervals of the underlying scores (e.g., 0.0 to 0.2, 0.2 to 0.4, . . . , 0.8 to 1.0), the bins can have asymmetrical ranges (e.g., 0.0 to 0.2, 0.2 to 0.6, 0.6 to 0.65, 0.65 to 1.0). More specifically, score binning 222 involves assigning ranges to each bin according to a distribution of the underlying raw scores such that each bin (and corresponding score range) will include a same number of items (or a similar number of items within any predetermined threshold). These bins are referred to as “asymmetric” bins to reflect the fact that each bin has a different (learned) range of assigned scores (e.g., a first bin might cover a relatively small range of scores from 0.0 to 0.1, while a second bin might cover scores ranging from 0.1 to 0.8, etc.). This is in contrast to symmetrical bin construction, where each bin is assigned a same range of scores (e.g., 0.0 to 0.1, 0.1 to 0.2, . . . , 0.9 to 1.0).

To illustrate, consider a binning operation of 100 documents, where each document has an uncalibrated score for a first model based on certain criteria, such as relevance or engagement potential. Assume that the scores for the 100 documents range from 0 to 100 and observe that the scores can be distributed arbitrarily (that is, scores can be distributed such that there are clusters of documents around certain score ranges, rather than being evenly spread). The goal is to distribute these 100 documents into two or more bins, each representing a range of uncalibrated scores, such that each bin contains approximately a same number of documents (or a number of documents within a predetermined binning tolerance of a targeted number of documents for each bin). In some embodiments, an initial bin number is predetermined, or selected, and the documents are binned in accordance with bin score ranges selected to satisfy the predetermined binning tolerance. For example, the initial bin number might be 4, and score binning 222 might include assigning score ranges to the bins such that each bin includes 25 documents (or a number of documents within a predetermined binning tolerance of 25 documents, such as 22 to 28 documents, or 24 to 26 documents, etc.). Continuing with this example, score binning 222 might include assigning the following score ranges to the bins: bin 1 [0 to 20], bin 2 [21 to 27], bin 3 [27 to 62], and bin 4 [62 to 100]. Note that, by construction, each bin now includes a same number of documents (or within a predetermined binning tolerance). In other words, this approach to binning, which considers the distribution of scores rather than fixed intervals, ensures that each bin is populated with a similar number of documents. In some embodiments, it might not be possible to distribute the documents equally among the initial bins. In this scenario, the number of bins can be increased, or decreased, and the distribution can be re-evaluated. This process can repeat iteratively until the number of bins, and the distribution of documents to those bins, satisfies the predetermined binning tolerance.

Once score binning 222 is complete, and a number of documents have been mapped to various bins, a bin mapping 224 is generated to map the underlying uncalibrated score data 216 to quantized bin identifiers. In some embodiments, quantized bin identifiers are numerical labels assigned to discrete bins that represent a ranges of scores or values in a dataset, although other configurations are possible and within the contemplated scope of this disclosure. For example, the raw score 0.14 might be mapped to bin [2], while the raw score 0.77 might be mapped to bin [16], and so on. Continuing with the previous example, Table 1 shows an example bin map for 40 documents (e.g., Document 1, Document 2, . . . , Document 40) having scores ranging between 0 and 100. Observe that, while each bin covers a different range of scores (and each range has a different size), each bin has a same number of documents (here, 10 documents).

TABLE 1
Bin Map

| | Bin A | Bin B | Bin C | Bin D |
|---|---|---|---|---|
| | (0-20) | (21-27) | (27-62) | (62-100) |
| Assigned | Document 1, | Document 2, | Document 5, | Document 12, |
| Documents | 7, 8, 23, 24, | 3, 4, 15, 19, | 6, 9, 10, 11, | 13, 14, 20, 28, |
| (10 each): | 25, 31, 36, 37, | 21, 22, 26, 32, | 16, 17, 18, 27, | 29, 30, 35, 38, |
| | 40 | 33 | 34 | 39 |

The bin mapping 224 (or bin map) is passed to a bin probability estimator 226. Bin probability estimator 226 assigns a probabilistic score to each bin generated during score binning 222. More specifically, for each bin i, bin probability estimator 226 approximates the likelihood that documents within the respective bin are assigned a positive label (e.g., “1”). Formally, bin probability estimator 226 determines, for each bin i, the probability p (y=1|x_{bin}=i), where y is a label, such as a probabilistic interaction label having valid scores of 0 (user did not interact with document) or 1 (user did interact with document). Of course, the label itself need not be limited specifically to probabilistic interaction labels, and other label types are within the contemplated scope of this disclosure. In other words, bin probability estimator 226 determines and assigns a probability to each bin, where that probability measures a likelihood that items (e.g., documents) within the respective bin will be positively labeled according to the underlying label of interest (e.g., probabilistic interaction labels or otherwise). The underlying label is interest is not meant to be particularly limited. In the context of off-policy evaluation, “positively labeled” refers to the assignment of a positive outcome or interaction to a candidate item, such as a document, based on user behavior or other criteria of interest. For example, consider a content recommendation system where a goal is to predict whether a user will click on a recommended article. In this scenario, a “positive label” (e.g., “1”) could be assigned to an article if the user clicks on it, indicating successful engagement. Conversely, if the user does not click on the article, it might receive a “negative label” (e.g., “0”). In other words, the bin probability estimator 226 assigns a probability to each bin representing the likelihood that items within that bin will be positively labeled (again, according to any desired underlying labeling policy). This probability is calculated based on historical data and observed interactions. For instance, if a bin contains articles that have historically received clicks from users 70 percent of the time, the bin might be assigned a probability of 0.7 for containing positively labeled items.

The probabilities can be assigned to the bins empirically during a training phase. For example, consider a first bin having, after score binning 222, thirty documents. During the training phase, the labels for each document in the first bin will be known. A probability score can therefore be empirically assigned to the first bin according to one or more predetermined statistical techniques, such as according to the average label scores of the documents assigned to the first bin. For example, if the scores of the ten documents assigned to the first bin are [1, 1, 0, 0, 1, 0, 1, 0, 0, 1], the average score of the documents is the first bin is 0.5, and therefore the probability score for the first bin can be set to 0.5. Additionally, or alternatively, probability scores can be empirically assigned by estimating the probability score as being equal to the ratio of the total number of items (documents) within a given bin having a positive reward to the total number of items generally. In any case, the calibration process can be repeated until probabilities are assigned to each bin.

Later, during an inference phase, the label for a document will not be known. Advantageously, however, the document can nevertheless be assigned to a bin by matching the document's uncalibrated score to the previously determined raw score ranges assigned during score binning 222. Then, from the bin assignment, the associated probabilistic score can be used in lieu of the uncalibrated score by downstream processes (e.g., by feed service 100). Observe that, by this construction, the learned probabilities (the calibrated score data 220) will be valid probabilities between 0 and 1 regardless of the underlying model type, score ranges, etc. In other words, the calibrated score data 220 are invariant to MOO scaling. In this manner, the model-free calibration module 218 enables efficient and robust off-policy estimation.

Returning now to the training phase, the calibration process (score binning 222, bin mapping 224, and bin probability estimator 226) itself can then be repeated for each model of the candidate models 208. More specifically, uncalibrated scores can be determined for the documents according to another model, and those scores can be binned and associated with previously determined bin probabilities in a similar manner as already described. Advantageously, and continuing with the earlier example, observe that, by construction, the model-free score calibration module 218 can learn the same probabilities via score binning 222 for the documents across any number of candidate models, regardless of score differences and/or MOO scaling within the underlying models. In other words, a first document assigned a score [0.23] by a first model can be assigned to a first bin according to a first distribution of scores by the first model, and that same first document, assigned a score by a second model, can also be assigned to the first bin according to a second distribution of scores by the second model. This result follows from the fact that the scores from both models, although arbitrarily varied in range and/or scale, will have a similar distribution, as they are scoring the same corpus of documents. That is, if a first model scores “good” documents as those having click propensity scores above 0.7 and up to 1.0, and a second more scores “good” documents as those having click propensity scores above 70 and up to 100, the distribution of those scores (and therefore their bin assignments) will be the same, or nearly the same (e.g., documents will be assigned to the same bin or an adjacent bin, regardless of the underlying model used to generated scores for the respective document).

Once the calibrated score data 220 are generated, a sampler 228 can generate validation subsets by sampling from the calibrated score data 220. In embodiments where the candidate models 208 are being evaluated against a baseline model, these training subsets can be used for off-policy estimation 230 (OPE). Off-policy estimation refers to a class of techniques for estimating how well a policy (e.g., a candidate model 208) performs using data collected from a different policy (e.g., a baseline model against which the candidate model 208 is evaluated). More specifically, the calibrated score data 220 generated from the logged data 210 can be sampled to define a subset of validation data for evaluating the candidate models 208 against each other, or against a baseline model, or both. The results of these evaluations (e.g., whether the scores of a candidate model 208 agrees with a baseline model, or known labels, etc.) are referred to as OPE estimates 232.

OPE estimates 232 might be generated, for example, for one or more candidate updates to a baseline model. In this scenario, each candidate update to the baseline model defines a separate candidate model 208, and sampled calibrated score data 220 for the respective candidate model 208 can be compared against the baseline model to generate the OPE estimates 232. In this manner, an entire set of candidate models 208 can be evaluated against a baseline model without needing to collect additional logged data 210. In other words, the logged data 210 can be data collected for a baseline model, and this data can be re-used by the universal off-policy estimator 200 to evaluate a set of candidate models 208.

In some embodiments, the OPE estimates 232 are passed to a confidence bound generator 234. In some embodiments, the confidence bound generator 234 is configured to analyze the variability and uncertainty within the OPE estimates 232 to determine the confidence bounds. To illustrate, consider that confidence bounds provide a range within which a true value of an estimated metric is statistically expected to lie at a specified level of confidence. In some embodiments, the confidence bound generator 234 assesses a variability metric of the OPE estimates 232. In some embodiments, accessing the variability metric involves calculating a statistical measure(s), such as the standard deviation or variance of the OPE estimates 232. Once the statistical measure is determined, a confidence level can be selected, typically expressed as a percentage (e.g., a 95% confidence level, a 90% confidence level, etc.). The confidence level indicates the probability that the true value of an estimated metric falls within the calculated confidence bounds. Once the statistical measure(s) and confidence level are known, the confidence interval required to satisfy the confidence level can be determined. While not meant to be particularly limited, confidence intervals can be determined using statistical techniques such as the t-distribution or normal distribution, depending on the sample size and distribution characteristics of the OPE estimates 232. In some embodiments, the confidence bound generator 234 can adjust the resultant confidence interval based on a sample size of the OPE estimates 234. In short, larger sample sizes generally lead to narrower confidence intervals, reflecting increased precision in the estimates, while smaller sample sizes generally lead to wider confidence intervals. However derived, the resulting confidence bounds can be output, by the confidence bound generator 234, as a range, typically expressed as a lower bound and an upper bound. This range provides a quantitative measure of the uncertainty associated with the OPE estimates 232, allowing downstream processes to assess the reliability of the various candidate models 208.

In some embodiments, the confidence bounds output by the confidence bound generator 234 are passed to a model selector 236. In some embodiments, the model selector 236 selects a candidate model 208 as a next ramp model 202 based at least in part on the confidence bounds and/or the OPE estimates 232. For example, when evaluating a set of 10 models against a baseline model, model selector 236 might select the model having the highest scores, or the scores which most closely agree with a baseline model as quantified by the OPE estimates 232. In addition, or alternatively, model selector 236 might select the model having a highest lower confidence bound. For example, a first model having a lower confidence bound of 92 percent might be selected over a second model having a lower confidence bound of 84 percent, even if the OPE estimates 232 for the second model are actually higher (e.g., the scores better align to a baseline model). In some embodiments, model selector 236 might select the ramp model 202 from a combination of the OPE estimates 232 and confidence bounds. In this manner, the universal off-policy estimator 200 can leverage existing logged data 210 to select new ramp models 202 from a plurality of candidate models 208.

In some embodiments, the model selection process (e.g., sampler 228, off-policy estimation 230, OPE estimates 232, confidence bound generator 234, and model selector 236) can be repeated two or more times using different subsets of validation data generated by sampler 228. For example, a set of candidate models 208 can be evaluated against a baseline model according to a first sampling by the sampler 228, and this process can be repeated with a second sampling (or third, etc.). Note that these repeated sampling processes can help to reduce sampling bias, as a single sampling pass might result in assigning higher, or lower, OPE estimates 232 to one or more of the candidate models 208 due to biases which are present within the sampled subset, but absent from the complete set of calibrated score data 220. This process can be referred to as sample bootstrapping (or simply, “bootstrapping”).

FIG. 3 depicts a process 300 for leveraging a universal off-policy estimator 200 for a feed service 100 in accordance with one or more embodiments. Process 300 begins with a feed service 100 having a second pass ranker 106 and one or more first pass rankers 110 (refer to FIG. 1). In some scenarios, it is desirable to update one or more of the second pass ranker 106 or the one or more first pass rankers 110. For example, such models might undergo periodic, scheduled updates to ensure that any changes in user behavior on the underlying platform (e.g., a connections network, social media platform, etc.) are captured and leveraged to create the most accurate model predictions possible. In another example, it may be desirable to test one or more changes to one of the models, such as changes to one or more learned weights or parameters of the model, to identify possible improvements to a model in service (e.g., ramp model 202).

In some embodiments, one or more candidate models 208 are passed to a model evaluation step 302. In some embodiments, step 302 also includes receiving, or fetching, logged data 210 from the feed service 100. During the model evaluation step 302, a plurality of multi-objective weights 304 can be generated, or received, for testing each of the one or more candidate models 208. In some embodiments, a grid of multi-objective weights 304 can be created by the candidate models 208. To illustrate, consider a scenario in which a content recommendation system is deployed to generate or evaluate candidate items for serving to a user(s). In a content recommendation system, multi-objective weights 304 might be used to balance user engagement and content diversity. In this scenario, a user engagement weight might be set to 0.7, while a content diversity weight might be set to 0.3. In this configuration, the system will focus roughly 70 percent of its optimization efforts on user engagement, and roughly 30 percent of its optimization efforts on content diversity. Of course, other weights can be assigned to user engagement and content diversity, and thus, an array of multi-objective weights 304 can be created for a single candidate model 208 by varying the weights assigned to user engagement and content diversity (e.g., weights can be assigned along a number of ratios, such as 70:30, 50:50, 30:70, 95:5, 10:90, etc.). This process can be repeated for each of the candidate models 208, resulting in a grid of multi-objective weights 304.

The multi-objective weights 304 can be passed to a candidate model evaluator 306. In some embodiments, candidate model evaluator 306 evaluates the candidate models 208 several times, for example, once for each candidate combination of multi-objective weights 304. The result is the generation, for each candidate model 208, of uncalibrated score data 216. In some embodiments, candidate model evaluator 306 includes, or is communicatively coupled to, a model-free score calibration module 218 (refer to FIG. 2).

In some embodiments, the uncalibrated score data 216 is passed to the model-free score calibration module 218. In some embodiments, the model-free score calibration module 218 generates calibrated score data 220 from the uncalibrated score data 216 as described previously. In some embodiments, the calibrated score data 220 is passed to a universal off-policy estimator 200 (refer to FIG. 2).

In some embodiments, the universal off-policy estimator 200 includes a sampler 228 configured to generate test data subsets from the calibrated score data 220. Optionally, in some embodiments, bootstrapping 308 can be leveraged to re-sample the calibrated score data 220, resulting in any number of desired test subsets.

In some embodiments, the universal off-policy estimator 200 generates OPE estimates 232 from the sampled subset of calibrated score data 220. The OPE estimates 232 can then be leveraged via a model selector 236, which can pass, to the feed service 100, one of more candidate models 208 as ramp models 202, in a similar manner as described previously. For example, model selector 236 can select from the candidate models 208 a ramp model 202 having a highest prediction accuracy as measured against known labels for the test data.

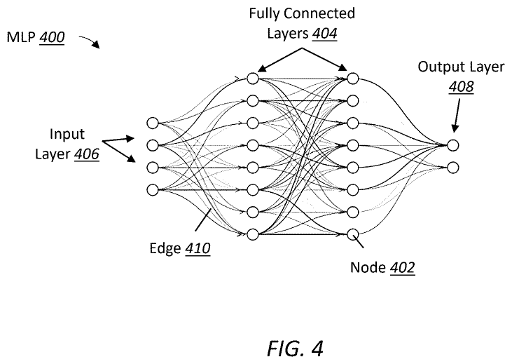

Turning now to FIG. 4, in some embodiments, one or more of the models (e.g., SPR 106 or an FPR 110 of FIG. 1, candidate models 208 of FIG. 2, etc.) previously described can be implemented in whole or in part as a multilayer perceptron (MLP) 400, which is a type of feedforward artificial neural network that consists of multiple layers of interconnected nodes 402. In this implementation, the MLP 400 includes one or more fully connected layers 404 using candidate features (refer, e.g., to candidate items 108 of FIG. 1) as input (collectively defining an input layer 406). In this type of implementation, the output layer 408 can include uncalibrated score data 216 for a candidate model 208 (refer, e.g., to FIG. 2). The depth, width, dimensionality, etc., of the MLP 400 need not be particularly limited, and the construction shown in FIG. 4 is merely illustrative.

In some embodiments, MLP 400 includes one or more nodes 402 (neurons) arranged in each of the fully connected layers 404. Nodes 402 in adjacent fully connected layers 404 are connected by weighted edges 410, where the weight of a respective edge represents the strength of the connection between the respective nodes 402. These weights are adjusted during a training phase. In some embodiments, each node 402 in the MLP 400 performs a weighted sum of its inputs, adds a bias term, and then, optionally, applies a non-linear activation function to produce an output. The nonlinear activation function, such as a rectified linear unit (ReLU), sigmoid, or tanh function, can be applied to the outputs of each node 402 to introduce nonlinearity to the output scores.

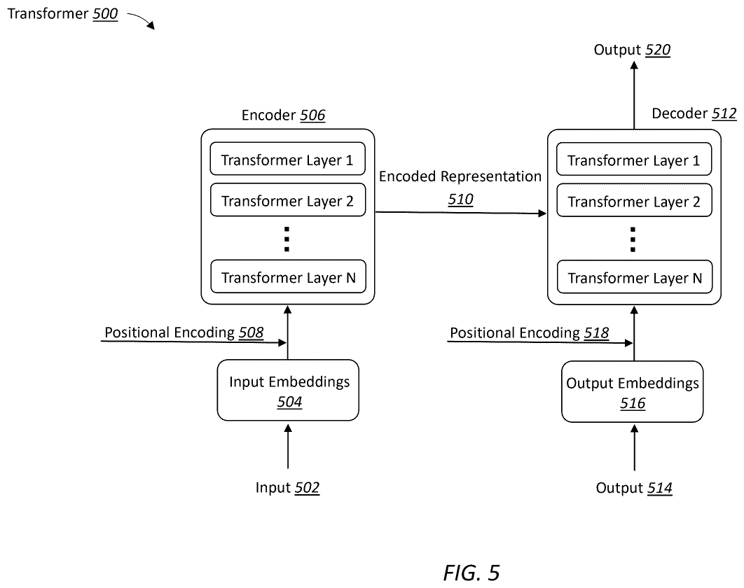

Turning now to FIG. 5, in some embodiments, one or more of the models (e.g., SPR 106 or an FPR 110 of FIG. 1, candidate models 208 of FIG. 2, etc.) previously described can be implemented in whole or in part using a transformer 500, such as those relied upon in some large language models (LLMs). In some embodiments, transformer 500 includes an encoder 506 trained to generate embeddings (e.g., candidate embeddings, user embeddings, actor embeddings, item embeddings, etc.). While not meant to be particularly limited, the transformer 500 and/or encoder 506 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

As shown in FIG. 5, the transformer 500 begins with an input 502. The input 502 denotes an input provided by a user (or upstream system) and can be represented as a sequence of tokens, individual words or sub-words, from which input embeddings 504 can be generated. The input embeddings 504 represent the tokens within the input 502 as numbers, which can be processed using encoder 506. In some embodiments, a positional encoding 508 can be generated to encode the position of each token in input 502 as a set of numbers. These numbers can be fed into the encoder 506 with the input embeddings 504, allowing the transformer-based architecture to more effectively understand the order of words in a sentence and to thereby generate grammatically correct and semantically meaningful outputs.

The encoder 506 processes the input embeddings 504 and the positional encoding 508 and generates, for the input 502, an encoded representation 510 that captures the meaning and context of the input 502. To accomplish this, encoder 506 applies a series of self-attention transformer layers (or simply, “transformer layers”), which are a series of hidden states that represent the input 502 at different levels of abstraction. The encoder 506 can include any number of these transformer layers, as desired. In some embodiments, the encoded representation 510 is provided to a decoder 512.

The decoder 512 similarly includes a number of transformer layers, as desired, except that the decoder 512 processes an output 514. In many implementations, the output 514 is a right-shifted copy of the input 502, meaning that the decoder 1112 can only use the previous words for next-token prediction. In some embodiments, output embeddings 516 can be generated from the output 514 to represent the tokens in the output 514 as numbers, in a similar manner as described with respect to the encoder 506. A positional encoding 518 can be added to the output embeddings 516 to encode the position of each token in output 514 as a set of numbers. The decoder 512 can be trained by minimizing a loss function (also known as an objective function, which quantifies a difference between a predicted output and a known true value) using, for example, gradient descent. Once trained, the transformer 500 can be used during an inference phase to generate an output 520, which can be thought of as a next-token probability (that is, how likely is the next token in the sequence to be x, or y, etc.). In some configurations, the transformer-based architecture includes a linear layer and softmax layer (omitted for clarity) to transform a raw output from the decoder 512 into the output 514. For example, after the decoder 512 produces a raw output (e.g., output embeddings), the linear layer can map the output embeddings to a higher-dimensional space, thereby transforming the output embeddings into a same original input space as the input 502. The softmax function can be used to generate a probability distribution for each output token in the vocabulary.

In the current implementation, the input 502 can include candidate items 108 (refer to FIG. 1) and output 520 and/or encoded representation 510 can include uncalibrated score data 216 (refer to FIG. 2). In other words, transformer 500 can be trained to generate, responsive to receiving input 502 including candidate items 108, an output 520 (or encoded representation 510 in encoder implementations) including candidate scores (e.g., the uncalibrated score data 216).

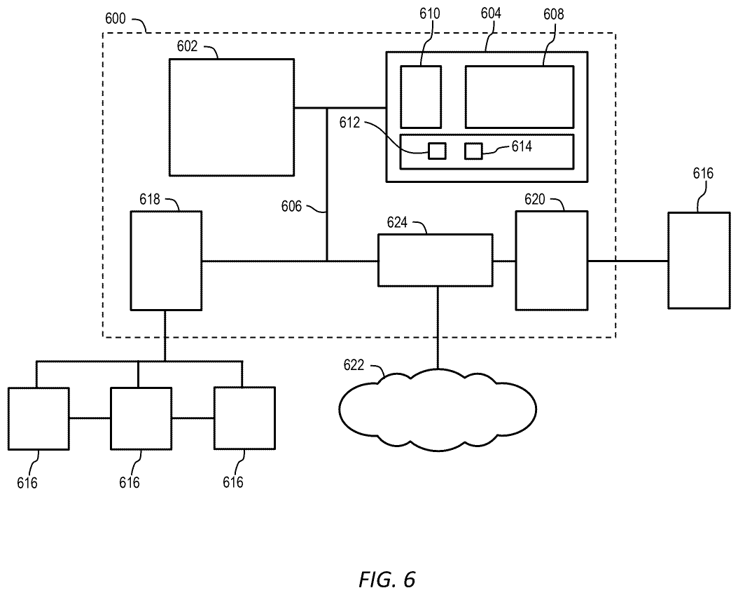

FIG. 6 illustrates aspects of an embodiment of a computer system 600 that can perform various aspects of embodiments described herein. In some embodiments, the computer system(s) 600 can implement and/or otherwise be incorporated within or in combination with the feed service 100 and/or second pass ranker 106 and/or one or more of the first pass rankers 110 described previously (refer to FIG. 1). In some embodiments, computer system 600 can be implemented server-side. For example, a remote computer system 600 can be configured to receive a ranking request 124, and in response, to generate a return 126 including the top K candidates for the ranking request 124. In another example, a remote computer system 600 can be configured to receive candidate models 208, and in response, to select a ramp model 202 for the feed service 100.

The computer system 600 includes at least one processing device 602, which generally includes one or more processors or processing units for performing a variety of functions, such as, for example, completing any portion of the feed service 100 and/or universal off-policy estimator 200 described previously. Components of the computer system 600 also include a system memory 604, and a bus 606 that couples various system components including the system memory 604 to the processing device 602. The system memory 604 may include a variety of computer system readable media. Such media can be any available media that is accessible by the processing device 602, and includes both volatile and non-volatile media, and removable and non-removable media. For example, the system memory 604 includes a non-volatile memory 608 such as a hard drive, and may also include a volatile memory 610, such as random access memory (RAM) and/or cache memory. The computer system 600 can further include other removable/non-removable, volatile/non-volatile computer system storage media.

The system memory 604 can include at least one program product having a set (e.g., at least one) of program modules that are configured to carry out functions of the embodiments described herein. For example, the system memory 604 stores various program modules that generally carry out the functions and/or methodologies of embodiments described herein. A module or modules 612, 614 may be included to perform functions related to any of the block diagrams described herein. The computer system 600 is not so limited, as other modules may be included depending on the desired functionality of the computer system 600. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 602 can also be configured to communicate with one or more external devices 616 such as, for example, a keyboard, a pointing device, and/or any devices (e.g., a network card, a modem, etc.) that enable the processing device 602 to communicate with one or more other computing devices. Communication with various devices can occur via Input/Output (I/O) interfaces 618 and 620.

The processing device 602 may also communicate with one or more networks 622 such as a local area network (LAN), a general wide area network (WAN), a bus network and/or a public network (e.g., the Internet) via a network adapter 624. In some embodiments, the network adapter 624 is or includes an optical network adaptor for communication over an optical network. It should be understood that although not shown, other hardware and/or software components may be used in conjunction with the computer system 600. Examples include, but are not limited to, microcode, device drivers, redundant processing units, external disk drive arrays, RAID systems, and data archival storage systems, etc.

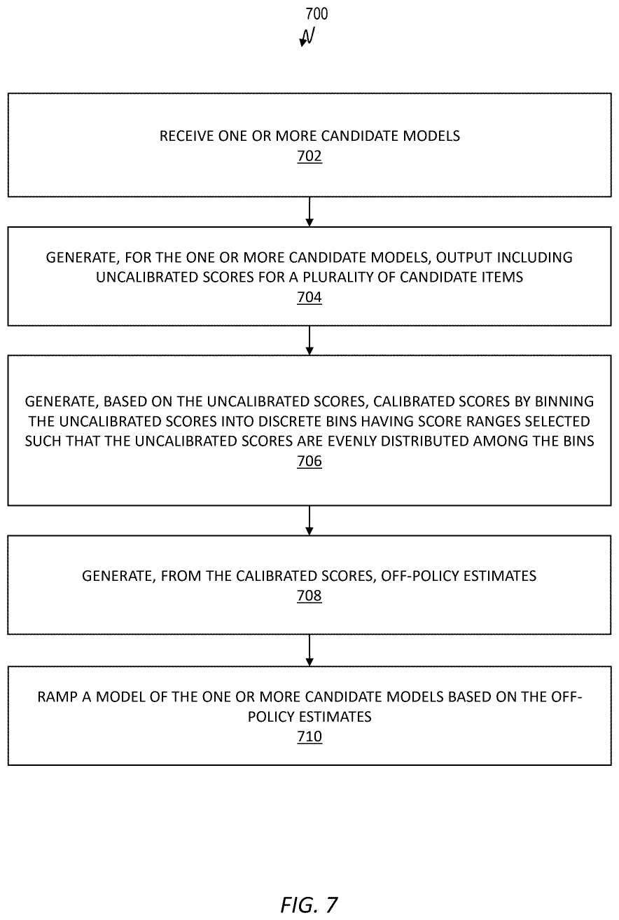

Referring now to FIG. 7, a flowchart 700 for universal off-policy estimation is generally shown according to an embodiment. The flowchart 700 is described with reference to FIGS. 1 to 6 and may include additional steps not depicted in FIG. 7. Although depicted in a particular order, the blocks depicted in FIG. 7 can be, in some embodiments, rearranged, subdivided, and/or combined.

At block 702, the method includes receiving one or more candidate models 208.

At block 704, the method includes generating, for the one or more candidate models 208, output comprising uncalibrated scores (e.g., uncalibrated score data 216) for a plurality of candidate items (e.g., logged data 210).

At block 706, the method includes generating, based on the uncalibrated scores, calibrated scores (e.g., calibrated score data 220). In some embodiments, generating the calibrated scores includes quantizing the uncalibrated scores into two or more discrete bins. In some embodiments, each bin of the two or more discrete bins is mapped to a discrete range of uncalibrated scores for the candidate items. In some embodiments, the discrete bins are assigned asymmetrical score ranges selected such that a difference between a number of uncalibrated scores assigned to each discrete bin is below a predetermined threshold. In some embodiments, the method includes assigning a probabilistic score to each bin of the two or more discrete bins. In some embodiments, the method includes assigning calibrated scores to the uncalibrated scores based on the respective bin assignments of the uncalibrated scores.

At block 708, the method includes generating, from the calibrated scores, off-policy estimates.

At block 710, the method includes ramping a model of the one or more candidate models based on the off-policy estimates.

In some embodiments, assigning the probabilistic scores includes determining, during a training phase and for each bin i of the two or more discrete bins, a probability that candidate items within the respective bin i are assigned a positive label. In some embodiments, for each bin, the probability that candidate items within the respective bin are assigned a positive label is empirically determined. In some embodiments, the probability is determined according to an average score of candidate items assigned to the respective bin. In some embodiments, the probability is determined according to a ratio of a number of candidate items assigned to the respective bin having a positive label and a total number of candidate items assigned to the respective bin.

In some embodiments, each bin of the two or more discrete bins contains a same number of uncalibrated scores. In some embodiments, two or more bins of the two or more discrete bins contains a different number of uncalibrated scores below a predetermined threshold tolerance.

In some embodiments, the method includes mapping each bin of the two or more discrete bins to a unique identifier. In some embodiments, off-policy estimates are generated from a sample of the calibrated scores.

In some embodiments, the calibrated scores are separately sampled two or more times, and off-policy estimates are generated for each resulting set of samples (refer to bootstrapping 308).

In some embodiments, the method includes, during an inference phase, receiving a candidate item, generating an output from the ramped model of the one or more candidate models, and delivering the candidate item to a user device according to the output (refer, e.g., to FIG. 1).

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method for universal off-policy estimation, the method comprising:
receiving one or more candidate models;
generating, for the one or more candidate models, output comprising uncalibrated scores for a plurality of candidate items;
generating, based on the uncalibrated scores, calibrated scores, wherein generating the calibrated scores comprises:
quantizing the uncalibrated scores into two or more discrete bins, each bin of the two or more discrete bins mapped to a discrete range of uncalibrated scores for the candidate items, the discrete bins having score ranges selected such that a difference between a number of uncalibrated scores assigned to each discrete bin is below a predetermined threshold;
assigning a probabilistic score to each bin of the two or more discrete bins; and
assigning calibrated scores to the uncalibrated scores based on the probabilistic scores of the respective bin assignments of the uncalibrated scores;
generating, from the calibrated scores, off-policy estimates; and
ramping a model of the one or more candidate models based on the off-policy estimates.

2. The method of claim 1, wherein assigning the probabilistic scores comprises determining, during a training phase and for each bin i of the two or more discrete bins, a probability that candidate items within the respective bin i are assigned a positive label.

3. The method of claim 2, wherein, for each bin, the probability that candidate items within the respective bin are assigned a positive label is empirically determined according to a ratio of a number of candidate items assigned to the respective bin having a positive label and a total number of candidate items assigned to the respective bin.

4. The method of claim 1, wherein each bin of the two or more discrete bins contains a same number of uncalibrated scores.

5. The method of claim 1, further comprising mapping each bin of the two or more discrete bins to a unique identifier.

6. The method of claim 1, wherein the off-policy estimates are generated from a sample of the calibrated scores.

7. The method of claim 6, wherein the calibrated scores are separately sampled two or more times, and off-policy estimates are generated for each resulting set of samples.

8. The method of claim 1, further comprising, during an inference phase:
receiving a candidate item;
generating an output from the ramped model of the one or more candidate models; and
delivering the candidate item to a user device according to the output.

9. The method of claim 1, wherein the calibrated scores are probabilistic scores invariant to multi-objective optimization (MOO) scaling.

10. A system comprising a memory, computer readable instructions, and one or more circuitry for executing the computer readable instructions, the computer readable instructions controlling the one or more circuitry to perform operations comprising:
receive one or more candidate models;
generate, for the one or more candidate models, output comprising uncalibrated scores for a plurality of candidate items;
generate, based on the uncalibrated scores, calibrated scores, wherein generating the calibrated scores comprises:
quantize the uncalibrated scores into two or more discrete bins, each bin of the two or more discrete bins mapped to a discrete range of uncalibrated scores for the candidate items, the discrete bins having asymmetrical score ranges selected such that a difference between a number of uncalibrated scores assigned to each discrete bin is below a predetermined threshold;
assign a probabilistic score to each bin of the two or more discrete bins; and
assign calibrated scores to the uncalibrated scores based on the respective bin assignments of the uncalibrated scores;
generate, from the calibrated scores, off-policy estimates; and
ramp a model of the one or more candidate models based on the off-policy estimates.

11. The system of claim 10, wherein assigning the probabilistic scores comprises determining, during a training phase and for each bin i of the two or more discrete bins, a probability that candidate items within the respective bin i are assigned a positive label.

12. The method of claim 11, wherein, for each bin, the probability that candidate items within the respective bin are assigned a positive label is empirically determined according to a ratio of a number of candidate items assigned to the respective bin having a positive label and a total number of candidate items assigned to the respective bin.

13. The system of claim 10, wherein each bin of the two or more discrete bins contains a same number of uncalibrated scores.

14. The system of claim 10, wherein the operations further comprise mapping each bin of the two or more discrete bins to a unique identifier.

15. The system of claim 10, wherein the off-policy estimates are generated from a sample of the calibrated scores.

16. The system of claim 15, wherein the calibrated scores are separately sampled two or more times, and off-policy estimates are generated for each resulting set of samples.

17. The system of claim 10, wherein the operations further comprise, during an inference phase:
receive a candidate item;
generate an output from the ramped model of the one or more candidate models; and
deliver the candidate item to a user device according to the output.

18. The system of claim 10, wherein the calibrated scores are probabilistic scores invariant to multi-objective optimization (MOO) scaling.

19. A computer program product comprising a computer readable storage medium having program instructions embodied therewith, the program instructions executable by one or more circuitry to cause the one or more circuitry to perform operations comprising:
receive one or more candidate models;
generate, for the one or more candidate models, output comprising uncalibrated scores for a plurality of candidate items;
generate, based on the uncalibrated scores, calibrated scores, wherein generating the calibrated scores comprises:
quantize the uncalibrated scores into two or more discrete bins, each bin of the two or more discrete bins mapped to a discrete range of uncalibrated scores for the candidate items, the discrete bins having asymmetrical score ranges selected such that a difference between a number of uncalibrated scores assigned to each discrete bin is below a predetermined threshold;
assign a probabilistic score to each bin of the two or more discrete bins; and
assign calibrated scores to the uncalibrated scores based on the respective bin assignments of the uncalibrated scores;
generate, from the calibrated scores, off-policy estimates; and
ramp a model of the one or more candidate models based on the off-policy estimates.

20. The computer program product of claim 19, wherein assigning the probabilistic scores comprises determining, during a training phase and for each bin i of the two or more discrete bins, a probability that candidate items within the respective bin i are assigned a positive label.
